(19) United States
(12) Patent Application Publication
(10) Pub. No.: US 2026/0338113 A1
(43) Pub. Date: Oct. 29, 2026

(54) TURBOJET ENGINE EQUIPPED WITH MEANS FOR MAINTAINING ITS OPERATION IN THE EVENT OF FAILURE OF ITS MAIN FUEL SUPPLY CIRCUIT

(71) Applicant: SAFRAN AIRCRAFT ENGINES, PARIS (FR)

(72) Inventors: Loïc PORA, MOISSY-CRAMAYEL (FR); Laurent Gilbert Yves HODINOT, MOISSY-CRAMAYEL (FR); Christian LEBOEUF, MOISSY-CRAMAYEL (FR)

(21) Appl. No.: 19/121,291

(22) PCT Filed: Oct. 17, 2023
(86) PCT No.: PCT/FR2023/051613

§ 371 Date: Apr. 15, 2025

(30) Foreign Application Priority Data
Oct. 19, 2022 (FR) 2210679

(51) Int. Cl. F02C 7/236; F02C 7/228; F02C 7/232; F02C 9/48; F02K 3/10; F23R 3/34

(52) U.S. Cl. CPC F02C 7/236; F02C 7/228; F02C 7/232; F02C 9/48; F02K 3/10; F23R 3/34

(57) ABSTRACT

A turbojet engine comprises: a combustion chamber and a jet pipe; a main circuit including a main centrifugal pump and a main positive displacement pump—supplying fuel to the injectors—of the combustion chamber, via a main regulator; an auxiliary circuit—including an auxiliary positive displacement pump for supplying pressurized fuel to the actuators of the jet pipe via an auxiliary regulator; a post-combustion circuit—including a post-combustion centrifugal pump, a post-combustion regulator and post-combustion injectors supplied by the post-combustion pump via the post-combustion regulator. A backup system connected to the auxiliary regulator and to the injectors-is provided so as to supply fuel to these injectors using the auxiliary pump in order to restart the turbojet engine in the event of a failure of the main circuit.

### TECHNICAL FIELD

The invention relates to a fuel supply system equipping a single-jet type aircraft turbojet engine, arranged to supply the engine including in the event of failure of a main supply circuit of this supply system.

### PRIOR ART

The invention relates to the fuel supply of an aircraft engine, such as a single-engine military aircraft, for which it is sought to maintain a fuel supply in the event of failure of a main fuel supply circuit equipping this engine.

In FIG. 1, such a turbojet engine 1 extending along an axis of rotation AX includes at its upstream AM an intake sleeve through which air is admitted to pass through a low-pressure compressor 2 before being split into a central primary flow and a secondary flow surrounding the primary flow.

The primary flow is then compressed in a high-pressure compressor 3 before reaching a combustion chamber 4, after which it is expanded through a high-pressure turbine 6 and a low-pressure turbine 7 before being discharged to the rear. The secondary flow is directed directly to the rear.

This turbojet engine is equipped downstream AV of the turbine 7 with an afterburner chamber 9, wherein the secondary flow joins the primary flow, and wherein fuel is injected to generate additional combustion making it possible to increase thrust.

Extending from the afterburner chamber, a nozzle 10 operated by cylinders not shown makes it possible to orient the flow exiting the engine in order to increase the manoeuvrability of the aircraft and/or modify the cross-section of the neck of this nozzle to adapt it to the operating conditions.

Such an engine is equipped with a main fuel supply circuit comprising a pump and a regulator to supply injectors in order to supply fuel to the combustion chamber, but a failure in this main circuit may result in a shutdown of the engine.

To allow a restart of the engine if such a failure occurs, one possibility consists of providing a redundancy of the main circuit. This entails an increase in the mass of the engine, since it is then necessary to provide an additional pump and its mechanical drive system via a rotary engine shaft.

Another possibility consists of providing a redundancy of only some of the components of the main circuit, but this does not make it possible to cover the case of a main circuit pump failure.

The aim of the invention is that of providing a solution allowing restarting and resumption of operation of such an engine in the event of failure of its main supply circuit, without significant addition of mass.

### DISCLOSURE OF THE INVENTION

To this end, the invention relates to a turbojet engine comprising:
a combustion chamber and a nozzle;
a main circuit including a main centrifugal pump and a main positive-displacement pump supplying fuel to the injectors of the combustion chamber, via a main regulator;
an auxiliary circuit including an auxiliary positive-displacement pump to supply pressurised fuel to the nozzle cylinders, via an auxiliary regulator;
characterised in that it includes a backup system connected to the auxiliary regulator and the injectors to supply these injectors with fuel with the auxiliary pump to restart the turbojet engine in the event of failure of the main circuit.

This architecture allows the engine to operate in the event of a simple main power supply circuit failure capable of causing this engine to shut down, without having to add a backup pump or a mechanical drive element of such a backup pump.

The invention also relates to a turbojet engine thus defined, wherein the backup system comprises a pressure limiter.

The invention also relates to a turbojet engine thus defined, wherein the backup system comprises a backup regulator, and wherein the pressure limiter is inserted between the backup regulator and the auxiliary regulator to which this backup system is connected.

The invention also relates to a turbojet engine thus defined, wherein the backup system comprises a controlled valve which is inserted between the auxiliary regulator and the pressure limiter to supply the pressure limiter when this valve is in an open state.

The invention also relates to a turbojet engine thus defined, wherein the backup system comprises a solenoid valve connected to the controlled valve to open or close it.

The invention also relates to a turbojet engine thus defined, wherein the main positive-displacement pump is a gear pump.

The invention also relates to a turbojet engine this defined, wherein the backup system includes a switch connected to the afterburner regulator and the injectors to supply the injectors from the auxiliary pump through the afterburner regulator to restart the engine in the event of main circuit failure.

The invention also relates to a turbojet engine thus defined, wherein the switch is connected to the afterburner regulator by a duct equipped with a non-return valve to stop the supply of the afterburner regulator by the auxiliary circuit when the afterburner pump is activated.

The invention also relates to a turbojet engine thus defined, wherein the backup system comprises a pressure selector connected to the main regulator and the pressure limiter to activate the backup system when the pressure of the main regulator is lower than the pressure of the pressure limiter.

The invention also relates to a turbojet engine thus defined, wherein the pressure selector comprises an output connected to variable geometries of the turbojet engine.

### BRIEF DESCRIPTION OF THE DRAWINGS

FIG. 1 is a longitudinal sectional view of a known afterburner turbojet engine;

FIG. 2 is a schematic representation of the fuel supply circuits of a military engine;

FIG. 3 is a schematic representation of the fuel supply circuits of a military engine according to the invention;

FIG. 4 is a schematic representation of a regulator in the case where the auxiliary positive-displacement pump is of the variable displacement type;

FIG. 5 is a schematic representation of the fuel supply circuits of a military engine according to a second embodiment of the invention in a normal operating configuration;

FIG. 6 is a schematic representation of the fuel supply circuits of a military engine according to a second embodiment of the invention in a restart configuration upon main circuit failure;

FIG. 7 is a schematic representation of the fuel supply circuits of a military engine according to a second embodiment of the invention in an operating configuration after restart following a main circuit failure.

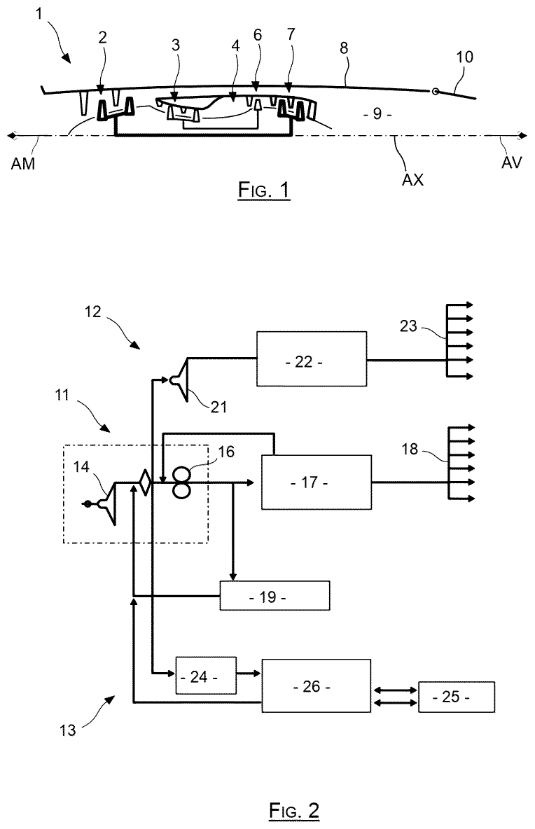

### DETAILED DISCLOSURE OF SPECIFIC EMBODIMENTS

A military engine includes, as shown in FIG. 2, a main fuel supply circuit 11, an afterburner fuel supply circuit 12 and an auxiliary fuel supply circuit 13.

The main circuit 11 is intended to supply the fuel to a main combustion chamber of the engine, and to supply variable geometries of the engine with the power required to operate them. These variable geometries are, for example, stationary compressor blades having a hydraulically operated variable pitch.

This main circuit 11 includes a main centrifugal pump 14 mounted in series with a main positive-displacement pump 16 to supply a main hydromechanical regulator 17 which in turn supplies injectors 18 of the main combustion chamber of the engine.

The main pump 14 is a centrifugal pump, such that it delivers a fuel flow rate proportional to its rotational speed squared. The pump 16 is here a gear pump, it consists of a positive-displacement pump, such that it delivers a flow rate which is proportional to its rotational speed. These two pumps are driven by a rotary engine shaft, via a gearbox commonly referred to as AGB (Auxiliary Gear Box).

The positive-displacement pump 16 is sized to supply a sufficient fuel flow rate to allow the engine to start, i.e. when its rotational speed is low.

The flow rate delivered by the pumps 14 and 16 supplies the regulator 17 which is controlled to regulate the supply flow rate of the injectors 18 at a desired value particularly depending on the pilot's controls, so as to obtain a desired thrust value.

This flow rate also supplies variable geometries 19 of the engine which are, for example, stationary variable compressor pitch vanes, the pitch of which is controlled hydraulically with a circuit carrying fuel.

The afterburner circuit 12 is used to supply fuel to the afterburner chamber of the engine, which is intended to be activated from time to time during a flight.

This afterburner circuit 12 includes a centrifugal afterburner pump 21 located downstream of the main pump 14 and upstream of the afterburner regulator 22. It is also driven by a rotary engine shaft. This pump 21 supplies afterburner injectors 23 via an afterburner regulator 22 which is also controlled to regulate the supply flow rate of the injectors 23.

The main circuit 11 and the afterburner circuit 12 are so-called low-pressure circuits. They deliver the fuel to the injectors at a pressure in the region of 70 bar.

The auxiliary circuit 13, on the other hand, supplies the engine output nozzle cylinders, to modulate the orientation of this nozzle in order to increase the manoeuvrability of the aircraft during its flight and/or to modify the cross-section of its neck to adapt it to the operating conditions.

The auxiliary circuit 13 is a so-called high-pressure circuit in that it is dedicated to supplying nozzle cylinders. It delivers a supply at a pressure in the region of 200 bar, at lower flow rates than those of the low-pressure circuits.

This auxiliary circuit 13 includes an auxiliary positive-displacement pump 24, located downstream of the main pump 14, like the afterburner pump 21, and which supplies the cylinders 25 of the nozzle via an auxiliary regulator 26.

This pump 24 is a positive-displacement pump which may optionally be of the variable displacement type, and it is also driven by a rotary engine shaft.

The auxiliary regulator 26 is controlled to deliver the appropriate pressures and flow rates to the different cylinders of the nozzle to give it an orientation corresponding to setpoint values and/or to modify the cross-section of its neck.

According to the invention, a backup system 27 connected to the auxiliary regulator 26 and the injectors 18 is provided, to supply the injectors 23 with fuel in the event of failure of the main circuit 11, for example at the main pump 14 or the main regulator 17.

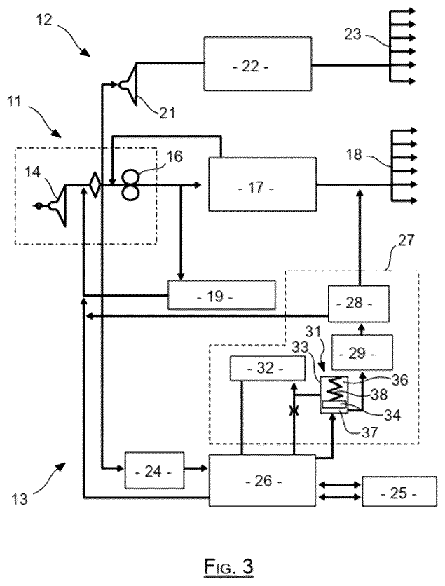

As can be seen in FIG. 3, the backup system 27 comprises a backup regulator 28, a pressure limiter 29, a controlled valve 31 and a solenoid valve 32.

The backup regulator 28 is connected to the auxiliary regulator 26 by the pressure limiter 29 and by the controlled valve 31 which is controlled by the solenoid valve 32 to be closed in normal operation and open in the event of failure of the main circuit 11.

The valve 31 includes a body 33 wherein a piston 34 slides, separating this body 33 into a control chamber 36 and a flow chamber 37 capable of being opened or closed. A spring 38 housed in the control chamber tends to move the piston 34 continually towards the flow chamber 37 to keep it closed.

The flow chamber 37 is continually connected to a high-pressure output of the regulator 26 and it is also connected to the pressure limiter 29 when the valve 31 is in the open state.

The control chamber 36 is supplied via a high-pressure output of the regulator 26 which ends with the solenoid valve 32. In normal operation, the solenoid valve 32 is kept closed, such that the pressures are substantially identical in the two chambers 36 and 37 of the valve 31, which then remains closed under the effect of the spring 38.

When a failure is detected at the main circuit 11, the solenoid valve 32 is commanded to open and discharge the flow rate passing through it to a return circuit. This causes the pressure in the control chamber 36 to drop, causing a movement of the piston 34 away from the chamber 37 in order to open it. This opening allows the flow of fuel through the valve 31, from the regulator 26 to the pressure limiter 29 which supplies the regulator 28 located downstream thereof, making it possible to supply the injectors 18.

Thus, during operation, a failure of the main circuit can result in a shutdown of the engine, its injectors 18 then no longer being supplied with fuel. In this case, the auxiliary positive-displacement pump 24 being operational, it continues to deliver a flow rate: opening of the solenoid valve 32 then makes it possible to open the valve 31 to supply the limiter 29 and the backup regulator 28, so as to supply fuel to the injectors 18 from the pump 24. Under these conditions, including if the engine is running at a low speed, the auxiliary pump 24 being of the positive-displacement type, it generates a sufficient flow rate to restart this engine.

In practice, prior to the opening of the solenoid valve 32, various actuators and solenoid valves of the auxiliary regulator 26 are controlled to lock the nozzle cylinders in a reference position, and to no longer supply them. The cylinders will then be in the fallback position and cannot be activated. Thus, when the solenoid valve 32 is open, the auxiliary pump 24 is entirely dedicated to supplying fuel to the injectors 18, and the nozzle which cannot be manoeuvred occupies a reference configuration.

Once the engine has been restarted, the auxiliary pump supplies a minimum fuel flow rate, lower than that of the main pump 14, allowing the aircraft to return to its base. If necessary, afterburning can be used, given that it is supplied by the afterburner circuit 12 which is separate and independent from the circuits 11 and 13.

In this operation, the pressure limiter 29 compensates for the differential pressure between the auxiliary circuit 13 (high pressure) and the nominal supply pressure for the injectors 18 (low pressure). The pressure limiter 29 receives a high-pressure fuel at the input, and delivers fuel at the output at a low pressure corresponding to that of circuit 11.

When the auxiliary positive-displacement pump 24 is a fixed displacement pump, the architecture of the backup regulator 28 is of the same type as that of the main regulator 17.

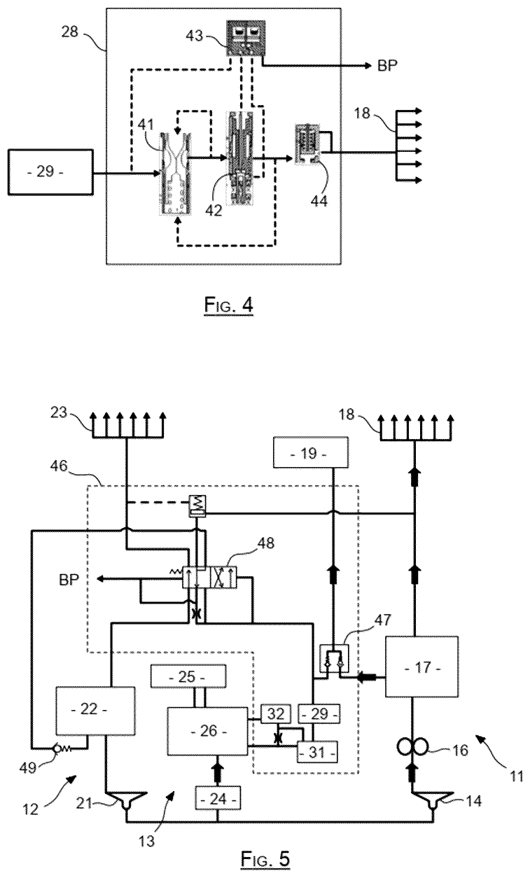

If the positive-displacement pump 24 is a variable displacement pump, it can deliver a flow rate and a pressure not solely dependent on the engine speed. The regulator 28 then advantageously includes, as shown in FIG. 4, means for delivering a predetermined output flow rate and pressure, i.e. independent of the displacement setpoint of this pump 24.

This regulator 28 then includes a variable restriction 41 receiving the fuel from the pressure limiter 29, this variable restriction 41 being controlled via the differential pressure of a metering valve 42 which it supplies. As can be seen in FIG. 4, the metering valve 42 is controlled by a servo valve 43 to deliver, via a sealing valve 44, a higher or lower flow rate to the injectors 18.

The variable restriction 41 is then connected upstream and downstream of the metering valve 42, so as to adapt the restriction it introduces to the differential pressure between the intake and the exhaust of the metering valve 42 controlled by the servo valve 43.

Under these conditions, when the servo valve 43 is commanded to increase the flow rate, it moves the metering valve 42, to increase its output flow rate. Under these conditions, the differential pressure between the intake and the exhaust of the metering valve 42 decreases, which controls the variable restriction 41 to reduce the restriction it causes in order to increase the pressure upstream of the metering valve 42, so as to restore an appropriate differential pressure between upstream and downstream of this metering valve 42. In other words, the variable restriction 41 makes it possible to adapt the pressure at the terminals of the metering valve 42 to regulate the flow rate to be injected.

The valve 44 is supplied by the metering valve 42 and is connected to the injectors 18. In normal operation, the pressure limiter 29 is switched off by the valve 31. The backup regulator 28 is then returned to the low pressure from the centrifugal pump 14. As the pressure at the injectors 18 is higher than the low pressure, the slide of the valve 44, assisted by a spring, ensures tightness between the main circuit and the backup system.

In this first embodiment, any variable geometries of the engine are returned to a fixed or default position, wherein they do not need to be controlled, when a failure is detected at the main circuit 11.

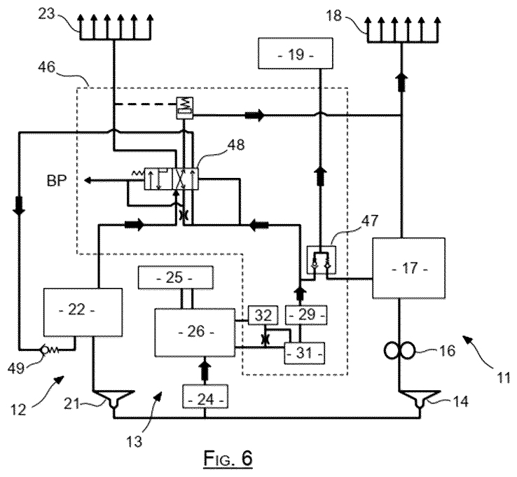

According to a second embodiment corresponding to FIGS. 5 to 7, the backup regulator is arranged to restart the engine by first actuating the auxiliary positive-displacement pump 24 by locking the cylinders 25, and to subsequently use the centrifugal afterburner pump 21 to make the cylinders 25 manoeuvrable again, to restore an almost normal operation of the engine.

In this second embodiment, the main circuit 11, the afterburner circuit 12 and the auxiliary circuit 13 have the same arrangements and the same components as in the example of FIG. 2, the circuits 11 and 12 also being low-pressure circuits, the auxiliary circuit 13 also being a high-pressure circuit.

As can be seen in FIG. 5, the backup system, referenced 46, is connected to the auxiliary regulator 26, the afterburner regulator 22, the variable geometries 19, and the combustion injectors 18.

The backup system 46 includes, as in the case of FIG. 3, a valve 31 connected to an output of the auxiliary regulator 26, a solenoid valve 32 and a pressure limiter 29. Activating the solenoid valve 32 makes it possible to open the valve 31 to supply the pressure limiter 29 with the output of the auxiliary regulator 26. This backup system 46 further includes a pressure selector 47, and a switch 48.

The pressure selector 47 has one of its inputs connected to an output of the pressure limiter 29 and its other input connected to an output of the main regulator 17, and the output of this selector 47 is directly connected to the variable geometries 19.

In normal operation, the solenoid valve 32 is closed, such that the pressure limiter 29 is not pressurised: its output pressure is lower than that of the regulator 17. Under these conditions, the selector 47 selects the regulator 17 as the supply source to supply the variable geometries 19, and the injectors 18 are also supplied by this regulator 17 in that they are directly connected to its output.

The switch 48, which is here a slide valve, is continually returned by a spring to its so-called normal position, wherein this switch connects the output of the afterburner regulator 22 to the afterburner injectors 23 in order to supply them.

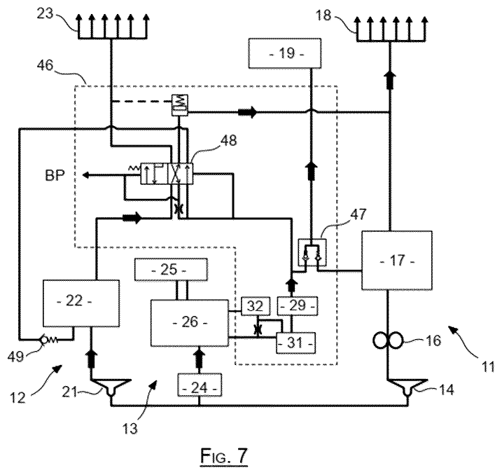

When a malfunction is detected on the main circuit 11, the solenoid valve 32 is controlled to open in order to pressurise the pressure limiter 29 such that this limiter 29, supplied by the auxiliary pump 24, then becomes the supply source of the variable geometries 19. In addition, this limiter 29 is connected to the switch 48 so that its pressurisation causes this switch 48 to switch from its normal state to its emergency state, which corresponds to the scenario in FIG. 6.

Prior to the activation of the solenoid valve 32, the cylinders 25 are locked in a reference position, and are no longer supplied by the regulator 26, so that the latter is available to supply the injectors 18 in order to restart the engine.

When the switch 48 is in the backup position, on one hand, it connects one of the outputs of the limiter 29 to an input of the afterburner regulator 22, and, on the other, it connects the output of this regulator 22 to the combustion injectors 18, instead of connecting it to the combustion injectors 18.

In this scenario, which corresponds to FIG. 6, the injectors 18 are supplied by the auxiliary pump 24, successively through the auxiliary regulator 26, the pressure limiter 29, and the afterburner regulator 22.

Once the engine has been restarted and it has reached a sufficient speed, the afterburner pump 21 can then be activated to ensure a nominal supply of the injectors 18, while freeing up the auxiliary circuit 13 which can once again be controlled to supply the cylinders 25 of the nozzle, as well as the cylinders of the variable geometries 19 in the event of a failure of the main circuit resulting in a decrease in the output pressure of the main pump 16.

As can be seen in the figures, the duct connecting the switch 48 to the regulator 22 is equipped with a non-return valve 49, here a ball valve, to stop the supply of the regulator 22 from the auxiliary circuit 13 as soon as the pressure of the regulator 22 becomes higher than that of the circuit 13 when the afterburner pump 21 is activated.

In this scenario, which is illustrated in FIG. 7, the engine is validly supplied with fuel by the afterburner circuit 12, and its nozzle as well as its variable geometries 19 are manoeuvrable thanks to the auxiliary circuit 13, despite the failure of the main supply circuit 11.

In this configuration, the invention allows the turbojet to be used under all flight conditions, except for the use of the afterburner circuit.

What is claimed is:

1. Turbojet engine comprising:
a combustion chamber and a nozzle;
a main circuit including a main centrifugal pump and a main positive-displacement pump supplying fuel to the injectors of the combustion chamber, via a main regulator;
an auxiliary circuit including an auxiliary positive-displacement pump to supply pressurised fuel to the nozzle cylinders, via an auxiliary regulator;
an afterburner circuit including a centrifugal afterburner pump, an afterburner regulator and afterburner injectors supplied by the afterburner pump through the afterburner regulator;
wherein it includes a backup system connected to the auxiliary regulator and the injectors to supply these injectors with fuel with the auxiliary pump to restart the turbojet engine in the event of failure of the main circuit.

2. The turbojet engine according to claim 1, wherein the backup system comprises a pressure limiter.

3. The turbojet engine according to claim 2, wherein the backup system comprises a backup regulator, and wherein the pressure limiter is inserted between the backup regulator and the auxiliary regulator to which this backup system is connected.

4. The turbojet engine according to claim 2, wherein the backup system comprises a controlled valve which is inserted between the auxiliary regulator and the pressure limiter to supply the pressure limiter when this valve is in an open state.

5. The turbojet engine according to claim 4, wherein the backup system comprises a solenoid valve connected to the controlled valve to open or close it.

6. The turbojet engine according to claim 1, wherein the main positive-displacement pump is a gear pump.

7. The turbojet engine according to claim 2, wherein the backup system includes a switch connected to the afterburner regulator and the injectors to supply the injectors from the auxiliary pump through the afterburner regulator to restart the turbojet engine in the event of failure of the main circuit.

8. The turbojet engine according to claim 7, wherein the switch is connected to the afterburner regulator by a duct equipped with a non-return valve to stop the supply of the afterburner regulator by the auxiliary circuit when the afterburner pump is activated.

9. The turbojet engine according to claim 7, wherein the backup system comprises a pressure selector connected to the main regulator and the pressure limiter to activate the backup system when the pressure of the main regulator is lower than the pressure of the pressure limiter.

10. The turbojet engine according to claim 9, wherein the pressure selector includes an output connected to variable geometries of the turbojet.
